(19) United States
(12) Patent Application Publication
(10) Pub. No.: US 2026/0242235 A1
(43) Pub. Date: Aug. 20, 2026

(54) SPHERICAL TITANIUM DIOXIDE COMPOSITE NANOPARTICLES, AND METHOD FOR PREPARING SAME BY USING SOL-GEL PROCESS

(71) Applicant: POSTECH RESEARCH AND BUSINESS DEVELOPMENT FOUNDATION, Pohang-si, Gyeongsangbuk-do (KR)

(72) Inventors: Gira YI, Pohang-si (KR); Jeongbin MOON, Pohang-si (KR); Chanseul KIM, Pohang-si (KR)

(73) Assignee: POSTECH RESEARCH AND BUSINESS DEVELOPMENT FOUNDATION, Pohang-si, Gyeongsangbuk-do (KR)

(21) Appl. No.: 19/161,516

(22) PCT Filed: Feb. 29, 2024
(86) PCT No.: PCT/KR2024/002619

§ 371 Date: Sep. 2, 2025

(30) Foreign Application Priority Data
Apr. 24, 2023 (KR) 10-2023-0053539

(51) Int. Cl. C01G 23/00

(52) U.S. Cl. CPC C01G 23/003; C01P 2002/30; C01P 2002/70; C01P 2004/32; C01P 2004/61; C01P 2004/62; C01P 2004/64

(57) ABSTRACT

Spherical titanium dioxide composite nanoparticles, and a method for preparing same by using a sol-gel process are disclosed. The composite nanoparticles comprise a compound represented by Chemical Formula TiₓSi₁₋ₓO₂, and are prepared by reacting, through a sol-gel process, a titanium dioxide precursor and a silica precursor, and thus maintain a spherical particle shape even during high-temperature heat treatment and have a high refractive index and uniform size distribution.

### TECHNICAL FIELD

The present disclosure relates to spherical titanium dioxide composite nanoparticles, and method for preparing same by using sol-gel process.

### BACKGROUND ART

Ultraviolet (UV) rays emitted from sunlight are known to cause skin erythema, freckles, skin cancer, and skin aging, and research on skin diseases caused by them is actively being conducted.

To block the ultraviolet rays contained in sunlight, inorganic substances with high refractive indexes that can reflect ultraviolet rays or organic substances that absorb ultraviolet rays are used in sunscreens. Here the inorganic substances with high refractive indexes such as titanium dioxide and zinc oxide are used.

The titanium dioxide currently in use in the past has mainly a figure of needle-shaped particles of several tens of in size. In the case of the needle-shaped nanometers nanoparticles, when used in cosmetics, there is an issue of toxic due to their shape, and there is a disadvantage that cosmetics easily clump together due to friction caused by their shape.

Meanwhile, spherical titanium dioxide particles have a low refractive index for use as a sunscreen in amorphous form, and their refractive index can be increased by heat treatment at high temperatures. However, when spherical particles are exposed to high temperatures, they can not maintain their spherical shape during the phase change process and transform into a crystalline phase, which leads to the issue of the particle shape becoming irregular during the transformation to crystalline phase.

Therefore, there is a need for the development of technology for composite nanoparticles containing titanium dioxide that can maintain a spherical shape even after when subjected to high-temperature heat treatment and a method for manufacturing same.

### DISCLOSURE

### Technical Problem

The purpose of the present disclosure is to provide composite nanoparticles comprising titanium dioxide that maintain a spherical shape during a high-temperature heat treatment process.

Another purpose of the present disclosure is to provide a simple method for manufacturing spherical composite nanoparticles comprising a titanium dioxide using a sol-gel process.

### Technical Solution

According to one aspect of the present disclosure, a spherical titanium dioxide composite nanoparticle comprising a compound represented by Chemical Formula 1 below is provided,

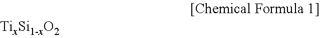

wherein in Chemical Formula 1,
x is in a range of 0.5<x<1.

In addition, a diameter of the spherical composite nanoparticle may be 0.01 to 10 μm.

In addition, the spherical composite nanoparticle may comprise a rutile crystal structure.

In addition, a part of oxygen atoms (O) chemically bonded with titanium atoms (Ti) may chemically bond with silicon atoms (Si).

In addition, the chemical bond may be at least one selected from the group consisting of a covalent bond and an ionic bond.

According to another aspect of the present disclosure, at least one selected from the group consisting of a sunscreen, a paint coating, a material for a solar cell and a water-splitting catalyst, preferably a sunscreen and a paint coating, comprising the spherical titanium dioxide composite nanoparticle is provided.

According to another aspect of the present disclosure, a method for preparing a spherical titanium dioxide composite nanoparticle is provided, and the method comprises: (a) preparing a mixture comprising a solvent, a titanium dioxide precursor and a silica precursor; (b) reacting the mixture through a sol-gel reaction; and (c) heat-treating a product of the sol-gel reaction, thus preparing a spherical titanium dioxide composite nanoparticle comprising a compound represented by Chemical Formula 1 below,

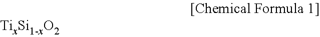

wherein in Chemical Formula 1,
x is in a range of 0.5<x<1.

In addition, a part of oxygen atoms (O) chemically bonded with titanium atoms (Ti) may chemically bond with silicon atoms (Si).

In addition, the chemical bond may be at least one selected from the group consisting of a covalent bond and an ionic bond.

In addition, the solvent may comprise a polar aprotic solvent, a C1 to C4 alcohol and a water.

In addition, the polar aprotic solvent may comprise at least one selected from the group consisting of acetonitrile, acetone, dimethylformamide, dimethylsulfoxide, ethylacetate, dichloromethane and dimethylacetamide.

In addition, the C1 to C4 alcohol may comprise at least one selected from the group consisting of methanol, ethanol, n-propanol, isopropanol and butanol.

In addition, the titanium dioxide precursor may comprise at least one selected from the group consisting of titanium isopropoxide (C₁₂H₂₈O₄Ti), titanium tetrachloride (TiCl₄), titanium butoxide (C₁₆H₃₆O₄Ti), titanium methoxide (C₄H₁₂O₄Ti) and titanium ethoxide (C₈H₂₄O₄Ti).

In addition, the silica precursor may comprise at least one selected from the group consisting of tetraethoxysilane (TEOS), tetramethyl orthosilicate, tetrapropyl orthosilicate, methyl triethyl orthosilicate, dimethyldiethyl orthosilicate, tetraisopropyl orthosilicate, tetrabutyl orthosilicate, tetrasecondarybutyl orthosilicate, tetratertiarybutyl orthosilicate, tetrahexyl orthosilicate, tetracyclohexyl orthosilicate and tetradodecyl orthosilicate.

In addition, the ratio of the number of moles of the silica precursor to the total number of moles of the titanium dioxide precursor (A) and the number of moles of the silica precursor (B) (B/(A+B)×100) may be 0.1 to 10 mol %.

In addition, the mixture of the step (a) further may comprise an organic amine.

In addition, the organic amine may comprise at least one selected from the group consisting of dodecylamine, octadecylamine, hexadecylamine, propylamine and butylamine.

In addition, the organic amine may be a compound represented by Chemical Formula 2 below,

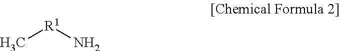

wherein in Chemical Formula 2,
R¹ may be C2 to C18 alkylene group or C2 to C18 alkenylene group.

In addition, R¹ may be C6 to C14 alkylene group.

In addition, the step (a) may comprise (a-1) mixing and stirring the solvent and the organic amine; (a-2) mixing and stirring the titanium dioxide precursor and the silica precursor; and (a-3) adding a product of the step (a-2) to a product of the step (a-1) and mixing them, thus preparing a mixture.

In addition, the sol-gel reaction of step (b) may be carried out at a room temperature.

In addition, heat-treating of the step (c) may be carried out at a temperature in a range of 700 to 1,000° C.

### Advantageous Effects

The spherical titanium dioxide composite nanoparticles of the present disclosure can maintain a spherical shape during a high-temperature heat treatment process while simultaneously achieving a high refractive index.

In addition, the spherical titanium dioxide composite nanoparticles of the present disclosure exhibit a uniform size distribution.

In addition, the method for preparing spherical titanium dioxide composite nanoparticles of the present disclosure enables to produce the spherical titanium dioxide composite nanoparticles in large quantities simply using a sol-gel method.

In addition, the method for preparing spherical titanium dioxide composite nanoparticles of the present disclosure can produce the spherical titanium dioxide composite nanoparticles with a single heat treatment, thus reducing time and cost.

### DESCRIPTION OF DRAWINGS

These drawings are for the purpose of describing exemplary embodiments of the present disclosure, and the technical idea of the present disclosure thus should not be construed as being limited to the accompanying drawings.

FIG. 1 shows a method for preparing spherical titanium dioxide composite nanoparticles according to the present disclosure.

FIG. 2 shows a rutile phase of spherical titanium dioxide composite nanoparticles manufactured according to Example 2 of the present disclosure.

FIG. 3 shows the results of XRD (X-ray diffraction data) analysis of spherical titanium dioxide composite nanoparticles manufactured according to Example 4 of the present disclosure.

FIG. 4 shows TEM and EDS Mapping images confirming the atomic-level mixing of spherical titanium dioxide composite nanoparticles manufactured according to Example 2 of the present disclosure.

FIG. 5 shows the refractive index measurements of spherical titanium dioxide composite nanoparticles manufactured according to Example 4 of the present disclosure.

FIG. 6 shows the size distribution results of spherical titanium dioxide composite nanoparticles manufactured according to Example 4 of the present disclosure.

### BEST MODE

Herein after, embodiments of the present disclosure will be described in detail with reference to the accompanying drawings in such a manner that the ordinarily skilled in the art can easily implement the embodiments of the present disclosure.

But the description given below is not intended to limit the present disclosure to specific embodiments. In relation to describing the present disclosure, when the detailed description of the relevant known technology is determined to unnecessarily obscure the gist of the present disclosure, the detailed description may be omitted.

The terminology used herein is for the purpose of describing particular embodiments only and is not intended to limit the scope of the present disclosure. As used herein, the singular forms “a”, “an” and “the” are intended to comprise the plural forms as well unless the context clearly indicates otherwise. It will be further understood that the terms “comprise” or “have” when used in the present disclosure specify the presence of stated features, integers, steps, operations, elements and/or combinations thereof, but do not preclude the presence or addition of one or more other features, integers, steps, operations, elements and/or combinations thereof.

Terms comprising ordinal numbers used in the specification, “first”, “second”, etc. can be used to discriminate one component from another component, but the order or priority of the components is not limited by the terms unless specifically stated. These terms are used only for the purpose of distinguishing a component from another component. For example, without departing from the scope of the present disclosure, a first component may be referred to as a second component and a second component may be also referred to as a first component.

In addition, when it is mentioned that a component is “formed”, “stacked” or “laminated” on another component, it should be understood such that one component may be directly attached to or directly stacked on the front surface or one surface of the other component or an additional component may be disposed between them.

Hereinafter, a spherical titanium dioxide composite nanoparticle and method for preparing same by using sol-gel process will be described in detail. However, those are described as examples and the present disclosure is not limited thereto and is only defined by the scope of the appended claims.

The present disclosure a spherical titanium dioxide composite nanoparticle comprising a compound represented by Chemical Formula 1 below is provided,

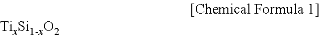

wherein in Chemical Formula 1,
x is in a range of 0.5<x<1.

In addition, a diameter of the spherical titanium dioxide composite nanoparticle may be 0.01 to 10 μm, preferably 0.05 to 1 μm, more preferably 0.1 to 0.5 μm. When the diameter of the spherical titanium dioxide composite nanoparticles is less than 0.01 μm, it is difficult for the particles to maintain a spherical shape, which is undesirable. When it is more than 10 μm, it is difficult to implement through the sol-gel method, which is undesirable.

In addition, the spherical titanium dioxide composite nanoparticle may comprise a rutile crystal structure.

In addition, a part of oxygen atoms (O) chemically bonded with titanium atoms (Ti) may chemically bond with silicon atoms (Si).

In addition, the chemical bond may be at least one selected from the group consisting of a covalent bond and an ionic bond.

The spherical titanium dioxide composite nanoparticles of the present disclosure are high-refractive index particles capable of reflecting ultraviolet ray, thus making them suitable for use in inorganic UV sunscreen, a paint coating, a material for a solar cell, a water-splitting catalyst, and other applications. In particular, when used in cosmetics, the spherical nanoparticles possess high refractive index characteristics, which can address toxicity issues related to their shape. Furthermore, they can address the problem of cosmetics clumping due to friction caused by their shape.

According to another aspect of the present disclosure, at least one selected from the group consisting of a sunscreen, a paint coating, a material for a solar cell and a water-splitting catalyst, preferably a sunscreen and a paint coating, comprising the spherical titanium dioxide composite nanoparticle, is provided.

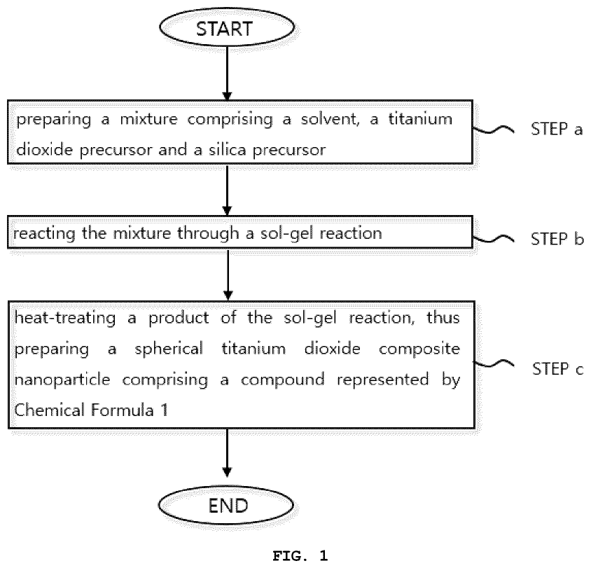

FIG. 1 shows a method for preparing spherical titanium dioxide composite nanoparticles according to the present disclosure. Hereinafter, referring FIG. 1, the method for preparing spherical titanium dioxide composite nanoparticles according to the present disclosure will be described in detail.

The present disclosure provides a method for preparing a spherical titanium dioxide composite nanoparticle, and the method comprises: (a) preparing a mixture comprising a solvent, a titanium dioxide precursor and a silica precursor; (b) reacting the mixture through a sol-gel reaction; and (c) heat-treating a product of the sol-gel reaction, thus preparing a spherical titanium dioxide composite nanoparticle comprising a compound represented by Chemical Formula 1 below,

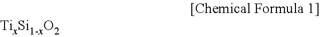

wherein in the Chemical Formula 1,
x is in a range of 0.5<x<1.

In addition, a part of oxygen atoms (O) chemically bonded with titanium atoms (Ti) may chemically bond with silicon atoms (Si).

In addition, the chemical bond may be at least one selected from the group consisting of a covalent bond and an ionic bond.

In addition, the solvent may comprise a polar aprotic solvent, a C1 to C4 alcohol and a water.

In addition, the polar aprotic solvent may comprise at least one selected from the group consisting of acetonitrile, acetone, dimethylformamide, dimethylsulfoxide, ethylacetate, dichloromethane and dimethylacetamide.

In addition, the C1 to C4 alcohol may comprise at least one selected from the group consisting of methanol, ethanol, n-propanol, isopropanol and butanol.

The water may be used in the sol-gel reaction.

Specifically, the alcohol and the polar aprotic solvent may be mixed at a volume ratio of 6:4 to 9:1, preferably 7.5:2.5 to 8:2, and more preferably 7:3. When the volume ratio of the alcohol and the polar aprotic solvent is less than 6:4 or more than 9:1, the size of the particles is formed unevenly, which is undesirable.

In addition, the titanium dioxide precursor may comprise at least one selected from the group consisting of titanium isopropoxide (C₁₂H₂₈O₄Ti), titanium tetrachloride (TiCl₄), titanium butoxide (C₁₆H₃₆O₄Ti), titanium methoxide (C₄H₁₂O₄Ti) and titanium ethoxide (C₈H₂₄O₄Ti).

In addition, the silica precursor may comprise at least one selected from the group consisting of tetraethoxysilane (TEOS), tetramethyl orthosilicate, tetrapropyl orthosilicate, methyl triethyl orthosilicate, dimethyldiethyl orthosilicate, tetraisopropyl orthosilicate, tetrabutyl orthosilicate, tetrasecondarybutyl orthosilicate, tetratertiarybutyl orthosilicate, tetrahexyl orthosilicate, tetracyclohexyl orthosilicate and tetradodecyl orthosilicate.

In addition, the ratio of the number of moles of the silica precursor to the total number of moles of the titanium dioxide precursor (A) and the silica precursor (B) (B/(A+B)×100) may be 0.1 to 10 mol %, and preferably 1 to 5 mol %. When the ratio of the number of moles of the silica precursor to the total number of moles is less than 0.1 mol %, the amount of silica contained is insufficient, and thus the characteristics of the composite nanoparticles cannot be exhibited, which is undesirable. When it is more than 10 mol %, the characteristics of titania cannot be exhibited due to the excessive silica contained, which is undesirable.

In addition, the mixture of the step (a) further may comprise an organic amine.

In addition, the organic amine may comprise at least one selected from the group consisting of dodecylamine, octadecylamine, hexadecylamine, propylamine and butylamine.

The dodecylamine can act as a catalyst. The dodecylamine can also participate in the reaction to form a precursor composite. The dodecylamine can reduce the reactivity of the titanium dioxide precursor, which can aid in the formation of spherical shape of titanium dioxide.

In addition, the organic amine may be a compound represented by Chemical Formula 2 below,

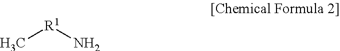

wherein in Chemical Formula 2,
R¹ may be C2 to C18 alkylene group or C2 to C18 alkenylene group.

In addition, R¹ may be C6 to C14 alkylene group.

In addition, the step (a) may comprise (a-1) mixing and stirring the solvent and the organic amine; (a-2) mixing and stirring the titanium dioxide precursor and the silica precursor; and (a-3) adding a product of the step (a-2) to a product of the step (a-1) and mixing them, thus preparing a mixture.

In addition, the sol-gel reaction of step (b) may be carried out at a room temperature.

In addition, heat-treating of the step (c) may be carried out at a temperature in a range of 700 to 1,000° C., and preferably 750 to 950° C. When the heat-treating is carried out at a temperature in a range of lower than 700° C., the rutile crystal phase may not be completely formed, which is undesirable. When it is carried out at a temperature in a range of more than 1,000° C., the composite nanoparticles may be dissolved and lose their original shape, which is undesirable.

Since the heat-treating is carried out only once throughout the entire preparing process, the present disclosure can reduce time and cost compared to conventional technologies that require two or more heat-treatings.

### MODE FOR DISCLOSURE

### Examples

Hereinafter, the examples of the present disclosure will be described. However, the examples are for illustrative purposes, and the scope of the present disclosure is not limited by the examples.

### Preparation of Spherical Titanium Dioxide Composite Nanoparticles

### Example 1: 0.1 mol %

A precursor mixture was prepared by mixing and stirring titanium isopropoxide, a precursor of titanium dioxide, and tetraethyl silicate, a precursor of silica, so that the molar % of tetraethyl orthosilicate (TEOS) with respect to the total molar number of titanium isopropoxide and tetraethyl orthosilicate was 0.1 mol %.

A mixture solution was prepared by adding 0.2 ml of distilled water and 0.5 ml of dodecylamine to 50 ml of a 7:3 mixture of methanol and acetonitrile and stirring for more than 30 minutes using a magnetic stirrer.

After stirring the mixture solution and the precursor mixture for at least 30 minutes respectively, 1 ml of the precursor mixture was quickly added to 50.7 ml of the mixture solution. The mixture solution into which the precursor mixture was added and was stirred at room temperature for at least 24 hours to carry out a sol-gel reaction, and then impurities and unreacted precursor were removed using a centrifuge and then dried.

The dried product was heat-treated in a sintering furnace at 900° C. for 6 hours to produce spherical titanium dioxide composite nanoparticles.

### Example 2: 0.5 mol %

Spherical titanium dioxide composite nanoparticles were prepared in the same manner as in Example 1, except that the molar percentage of tetraethyl silicate was used as 0.5 mol % instead of 0.1 mol % based on the total molar number of titanium isopropoxide, a precursor of titanium dioxide, and tetraethyl silicate, a precursor of silica.

### Example 3: 1 mol %

Spherical titanium dioxide composite nanoparticles were prepared in the same manner as in Example 1, except that the molar percentage of tetraethyl silicate was used as 1 mol % instead of 0.1 mol % based on the total molar number of titanium isopropoxide, a precursor of titanium dioxide, and tetraethyl silicate, a precursor of silica.

### Example 4: 2 mol %

Spherical titanium dioxide composite nanoparticles were prepared in the same manner as in Example 1, except that the molar percentage of tetraethyl silicate was used at 2 mol % instead of 0.1 mol % based on the total molar number of titanium isopropoxide, a precursor of titanium dioxide, and tetraethyl silicate, a precursor of silica.

### Example 5: 5 mol %

Spherical titanium dioxide composite nanoparticles were prepared in the same manner as in Example 1, except that the molar percentage of tetraethyl silicate was used at 5 mol % instead of 0.1 mol % based on the total molar number of titanium isopropoxide, a precursor of titanium dioxide, and tetraethyl silicate, a precursor of silica.

### Example 6: 10 mol %

Spherical titanium dioxide composite nanoparticles were prepared in the same manner as in Example 1, except that the molar percentage of tetraethyl silicate was used at 10 mol % instead of 0.1 mol % based on the total molar number of titanium isopropoxide, a precursor of titanium dioxide, and tetraethyl silicate, a precursor of silica.

The mol % of titanium isopropoxide, the titanium dioxide precursor and tetraethyl silicate, the silica precursor in Examples 1 to 6 are summarized in Table 1 below.

TABLE 1

| Classification | TTIP (mol %) | TEOS (mol %) |
|---|---|---|
| Example 1 | 99.9 | 0.1 |
| Example 2 | 99.5 | 0.5 |
| Example 3 | 99 | 1 |
| Example 4 | 98 | 2 |
| Example 5 | 95 | 5 |
| Example 6 | 90 | 10 |

### Test Example

### Test Example 1: Morphology Analysis

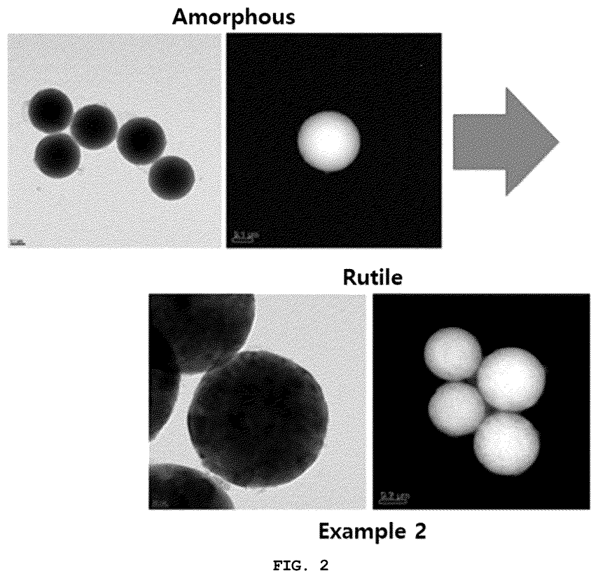

FIG. 2 shows the morphology of the composite nanoparticles of Example 2 observed using a scanning electron microscope (SEM, Hitachi, S-4300) and a transmission electron microscope (TEM, JEOL LTD, JEM2100F). Referring to FIG. 2, the spherical titanium dioxide composite nanoparticles according to the present disclosure are in a rutile phase. It can be confirmed that the spherical titanium dioxide composite nanoparticles can be simply prepared by a sol-gel reaction method even with high-temperature heat treatment by including a silica precursor.

### Test Example 2: Crystallinity Evaluation

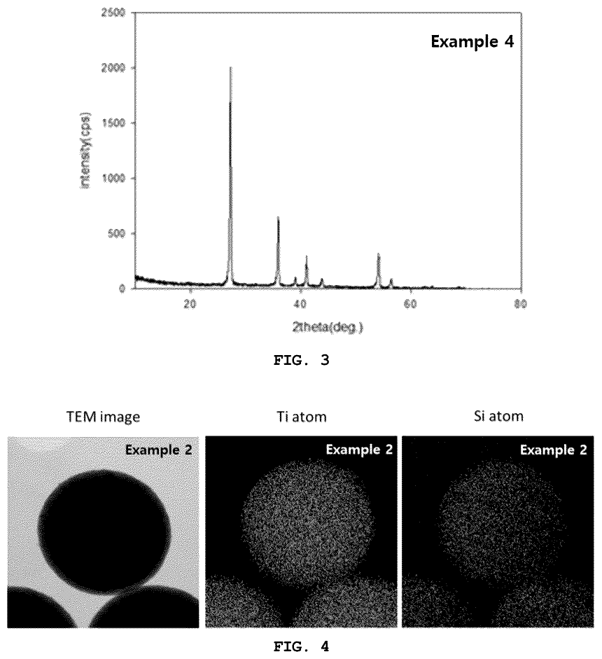

FIG. 3 shows the results of X-ray diffraction (XRD) analysis to confirm crystallinity of spherical titanium dioxide composite nanoparticles according to Example 4 of the present disclosure. The sample was prepared using 2 mol % TEOS, and the precursor molar ratio (mol %:mol %) of TTIP:TEOS was 98:2.

Referring to FIG. 3, X-ray diffraction peaks appearing due to the crystal structure of the rutile crystal phase can be confirmed.

### Test Example 3: Atomic Unit Bonding

FIG. 4 is a TEM and EDS Mapping image confirming the atomic-level mixing of spherical titanium dioxide composite nanoparticles according to Example 2 of the present disclosure.

Referring to FIG. 4, it was confirmed that the spherical titanium dioxide composite nanoparticles according to the present disclosure were bonded at the atomic level.

### Test Example 4: Refractive Index Analysis

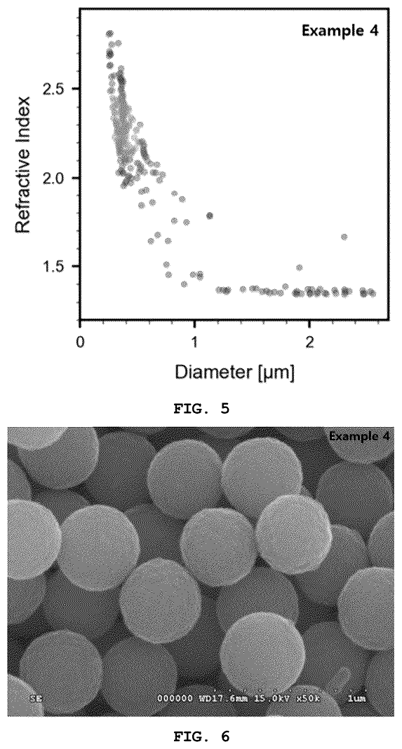

FIG. 5 shows the refractive index measurements of spherical titanium dioxide composite nanoparticles according to Example 4 of the present disclosure measured using holographic characterization equipment (xSight, Spheryx, Inc.). Here, each dot represents a measurement result for one sample, and the color of the dot indicates the distribution ratio.

Referring to FIG. 5, each dot represents the measurement results of the refractive index and diameter of a single rutile titania particle, and the color of the dots represents the distribution degree. The brighter the dot, the more dots there are gathered together, indicating a high distribution ratio. This shows that the spherical titanium dioxide composite nanoparticles according to the present disclosure have a high refractive index. As the refractive index increases, light scattering becomes stronger, and the effects of scattering color expression and ultraviolet ray blocking can be enhanced.

### Test Example 5: Confirmation of Size Distribution

FIG. 6 shows the size distribution of spherical titanium dioxide composite nanoparticles according to Example 4 of the present disclosure. Diameter observation using SEM showed that the size distribution was less than 10%.

Referring to FIG. 6, it can be seen that the spherical titanium dioxide composite nanoparticles according to the present disclosure have a uniform size distribution.

The scope of the present disclosure is defined by the following claims rather than the above detailed description, and all changes or modifications derived from the meaning and scope of the claims and their equivalent concepts should be interpreted as falling into the scope of the present disclosure.

1. A spherical titanium dioxide composite nanoparticle comprising a compound represented by Chemical Formula 1 below, 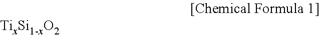
wherein in Chemical Formula 1,
x is in a range of 0.5<x<1.

2. The composite nanoparticle of claim 1, wherein a diameter of the composite nanoparticle is 0.01 to 10 μm.

3. The composite nanoparticle of claim 1, comprising a rutile crystal structure.

4. The composite nanoparticle of claim 1, wherein a part of oxygen atoms (O) chemically bonded with titanium atoms (Ti) chemically bonds with silicon atoms (Si).

5. The composite nanoparticle of claim 4, wherein the chemical bond is at least one selected from the group consisting of a covalent bond and an ionic bond.

6. A sunscreen, a paint coating, a material for a solar cell and a water-splitting catalyst comprising the spherical titanium dioxide composite nanoparticle according to claim 1.

7. A method for preparing a spherical titanium dioxide composite nanoparticle, the method comprising:
(a) preparing a mixture comprising a solvent, a titanium dioxide precursor and a silica precursor;
(b) reacting the mixture through a sol-gel reaction; and
(c) heat-treating a product of the sol-gel reaction, thus preparing a spherical titanium dioxide composite nanoparticle comprising a compound represented by Chemical Formula 1 below, 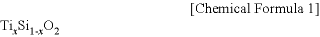
wherein in Chemical Formula 1,
x is in a range of 0.5<x<1.

8. The method of claim 7, wherein a part of oxygen atoms (O) chemically bonded with titanium atoms (Ti) chemically bonds with silicon atoms (Si).

9. The method of claim 8, wherein the chemical bond is at least one selected from the group consisting of a covalent bond and an ionic bond.

10. The method of claim 7, wherein the solvent comprises a polar aprotic solvent, a C1 to C4 alcohol and a water.

11. The method of claim 10, wherein the polar aprotic solvent comprises at least one selected from the group consisting of acetonitrile, acetone, dimethylformamide, dimethylsulfoxide, ethylacetate, dichloromethane and dimethylacetamide.

12. The method of claim 10, wherein the C1 to C4 alcohol comprises at least one selected from the group consisting of methanol, ethanol, n-propanol, isopropanol and butanol.

13. The method of claim 7, wherein the titanium dioxide precursor comprises at least one selected from the group consisting of titanium isopropoxide (C₁₂H₂₈O₄Ti), titanium tetrachloride (TiCl₄), titanium butoxide (C₁₆H₃₆O₄Ti), titanium methoxide (C₄H₁₂O₄Ti) and titanium ethoxide (CH₂₄O₄Ti).

14. The method of claim 7, wherein the silica precursor comprises at least one selected from the group consisting of tetraethoxysilane (TEOS), tetramethyl orthosilicate, tetrapropyl orthosilicate, methyl triethyl orthosilicate, dimethyldiethyl orthosilicate, tetraisopropyl orthosilicate, tetrabutyl orthosilicate, tetrasecondarybutyl orthosilicate, tetratertiarybutyl orthosilicate, tetrahexyl orthosilicate, tetracyclohexyl orthosilicate and tetradodecyl orthosilicate.

15. The method of claim 7, wherein the ratio of the number of moles of the silica precursor to the total number of moles of the titanium dioxide precursor (A) and the number of moles of the silica precursor (B) (B/(A+B)×100) is 0.1 to 10 mol %.

16. The method of claim 7, wherein the mixture of the step (a) further comprises an organic amine.

17. The method of claim 16, wherein the organic amine comprises at least one selected from the group consisting of dodecylamine, octadecylamine, hexadecylamine, propylamine and butylamine.

18. The method of claim 16, wherein the organic amine is a compound represented by Chemical Formula 2 below, 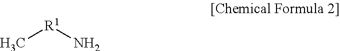
wherein in Chemical Formula 2,
R¹ is C2 to C18 alkylene group or C2 to C18 alkenylene group.

19. The method of claim 7, wherein the step (a) comprises:
(a-1) mixing and stirring the solvent and the organic amine;
(a-2) mixing and stirring the titanium dioxide precursor and the silica precursor; and
(a-3) adding a product of the step (a-2) to a product of the step (a-1) and mixing them, thus preparing a mixture.

20. The method of claim 7, wherein heat-treating of the step (c) is carried out at a temperature in a range of 700 to 1,000° C.
